(19) United States
(12) Patent Application Publication
(10) Pub. No.: US 2020/0100000 A1
(43) Pub. Date: Mar. 26, 2020

(54) BLACK BOX SYSTEM FOR LAND-BASED STRUCTURES AND PREMISES

(71) Applicant: ShadowTech Labs, Inc., Willowbrook, IL (US)

(72) Inventors: Michael Collins, Chicago, IL (US); David Nahlik, Chicago, IL (US); Dennis Collins, Park Ridge, IL (US); Inge Collins, Park Ridge, IL (US)

(21) Appl. No.: 16/581,641

(22) Filed: Sep. 24, 2019

Related U.S. Application Data
(60) Provisional application No. 62/735,482, filed on Sep. 24, 2018.

(51) Int. Cl. H04Q 9/00

(52) U.S. Cl. CPC H04Q 9/00; H04W 12/08

(57) ABSTRACT

A black box system for a land-based premises includes a black box device located in or near the premises. The black box device has a destruction resistant case or shell and operational components housed within the case or shell. The system has at least one remote component external to and in communication with the black box device and disposed at, on, or in the premises. The remote component is configured to collect information, signals, and/or data about premises conditions and to transmit the collected information, signals, and/or data to the black box device. The black box device receives the transmitted information, signals, and/or data from the remote component and stores same for a period of time before and/or during a triggering event. The stored transmitted information, signals, and/or data can be retrieved from the black box device after the triggering event.

### RELATED APPLICATION DATA

This patent is entitled to the benefit of and claims priority to co-pending U.S. Provisional Application Ser. No. 62/735,482 filed Sep. 24, 2018 and entitled “Black Box System for Land-Based Structures and Premises.” The entire contents of this prior filed application are hereby incorporated herein by reference.

### BACKGROUND

### 1. Field of the Disclosure

The present disclosure is generally directed to security and safety measures for land-based structures and premises, and more particularly to a black box information and data capturing system for such structures and premises.

### 2. Description of Related Art

Various types of security systems for buildings, structures, and premises are known in the art. These types of systems may include video monitoring systems, audio monitoring systems, and perimeter break-in type sensors and sensor monitoring systems. The systems are typically used to detect a breach of the building, structure, or premises by an intruder.

However, sometimes a building, a structure, or a premises is subject to a catastrophic event such as a bombing or an armed attack. The typical building security system will provide very little to no useful information about such an event because the system is often rendered non-functional as a result of such an event or is manually disabled by the perpetrators to avoid detection.

Airplanes are known to have a different type of monitoring system, known as a black box system, that records and stores information that can be obtained in the aftermath of a catastrophic event such as a plane crash. The typical black box system has a cockpit voice recorder and a flight data recorder contained in two separate boxes. The cockpit voice recorder stores cockpit conversations and sounds, which may yield valuable information for the time prior to a catastrophic event. The flight data recorder stores a multitude of different flight, sensor, and system data regarding the plane itself, which may yield valuable information for the time prior to a catastrophic event. These boxes are designed to survive a catastrophic event and to record and store data leading up to such an event. Once recovered, these boxes can provide important clues to aid in determining the cause of a catastrophic event suffered by the airplane.

### SUMMARY

In one example, according to the teachings of the present disclosure, a black box system for a land-based premises includes a black box device located in or near the premises. The black box device has a destruction resistant case or shell and operational components housed within the case or shell. The system includes at least one remote component external to and in communication with the black box device and disposed at, on, or in the premises. The remote component is configured to collect information, signals, and/or data about premises conditions and to transmit the collected information, signals, and/or data to the black box device. The black box device receives the transmitted information, signals, and/or data from the remote component and stores the transmitted information, signals, and/or data for a period of time before and/or during a triggering event. The stored transmitted information, signals, and/or data can be retrieved from the black box device after the triggering event.

In one example, the remote component can continue to transmit information, signals, and/or data to the black box device after the triggering event.

In one example, the stored transmitted information, signals, and/or data can be retrieved by an authorized responder via a secure wireless transmission.

In one example, the case or shell can be formed of a high strength, high density polymer.

In one example, can be configured to emit a transponder signal or ping upon the occurrence of the triggering event.

In one example, the black box device can be configured to erase, delete, or overwrite expired or old stored transmitted information, signals, and/or data after the period of time passes and when no triggering event has occurred and can be configured to collect new stored transmitted information, signals, and/or data.

In one example, the remote component and the black box device can be in wireless electronic communication, hard-wired electronic communication, or both.

In one example, the remote component can include a plurality of remote components.

In one example, the remote component can be a plurality of remote components, which can include one or more of a camera, an audio sensor, and a non-audio sensor.

In one example, the remote component can be a plurality of remote components, which can include one or more cameras, one or more audio sensors, and one or more non-audio sensors.

In one example, the at least one remote component can include at least one non-audio sensor, which can be selected from a group including a heat or thermal sensor, a perimeter breach sensor, a pressure or over-pressure sensor, a shock sensor, a seismic sensor, a vibration sensor, and a light sensor.

In one example according to the teachings of the present disclosure, a method of obtaining information, signals, and data from a land-based premises after a triggering event includes the step detecting a stimulus at or above a stimulus threshold via a component of a black box system installed at the land-based premises and then turning ON the component. The method includes transmitting information, signals, and/or data from the component to a black box device of the black box system, where the black box device is located remote from the component and in or near the premises. The method includes storing the transmitted information, signals, and/or data at the black box device. The method includes determining at the black box device if the detected stimulus meets or exceeds a triggering event threshold. If the detected stimulus meets or exceeds the triggering event threshold, the method includes retaining the stored transmitted information, signals, and/or data at the black box device and emitting a transponder signal or ping from the black box device. If the detected stimulus does not meet or exceed the triggering event threshold, after a predetermined period of time, the method includes turning OFF the components and erasing the stored transmitted information, signals, and/or data.

In one example, the component of the black box system can further have a plurality of components including one or more cameras, one or more audio sensors, and one or more other non-audio sensors. The step of turning ON can include turning ON each of the one or more cameras, audio sensors, and other non-audio sensors.

In one example, the method can include the steps of locating the black box device based on the transponder signal or ping and downloading the stored transmitted information, signals, and/or data.

In one example, the method can include a step of downloading the stored transmitted information, signals, and/or data and doing so remote from the black box device via a secure wireless transmission.

### BRIEF DESCRIPTION OF THE DRAWINGS

Objects, features, and advantages of the present invention will become apparent upon reading the following description in conjunction with the drawing figures, in which:

FIG. 1 shows a simplified schematic of one example of a black box system constructed in accordance with the teachings of the present disclosure and for a land-based premises.

FIG. 2 shows one example of a black box device for the black box system of FIG. 1 and constructed in accordance with the teachings of the present disclosure.

FIG. 3 shows one example of an arrangement of external connectors or ports of the black box device of FIG. 2.

FIG. 4 shows a flow chart of one example of a method of obtaining information, signals, and/or data from a land-based premises in accordance with the teachings of the present disclosure.

### DETAILED DESCRIPTION OF THE DISCLOSURE

The disclosed black box system is suitable for land-based buildings, structures, and premises. The disclosed system includes a black box device that houses internal components and that is configured to connect to external or remote devices and components of the system. The disclosed system can be employed, at least in part, within a land-based environment such as a building, a structure, or other premises. The disclosed system can utilize external or remote data collection components, such as one or more cameras, one or more audio pick-ups, microphones, or devices, and/or one or more sensors disposed about the building, structure, or premises. The disclosed system can detect an unusual event associated with the building, structure, or premises and collect, record and securely store data from the remote external components within a time period around the unusual event. The remote external components can communicate with the black box device and the black box device can be configured to collect, record, and securely store the data. These and other objects, features and advantages of the present disclosure will become apparent to those having ordinary skill in the art upon reading this disclosure.

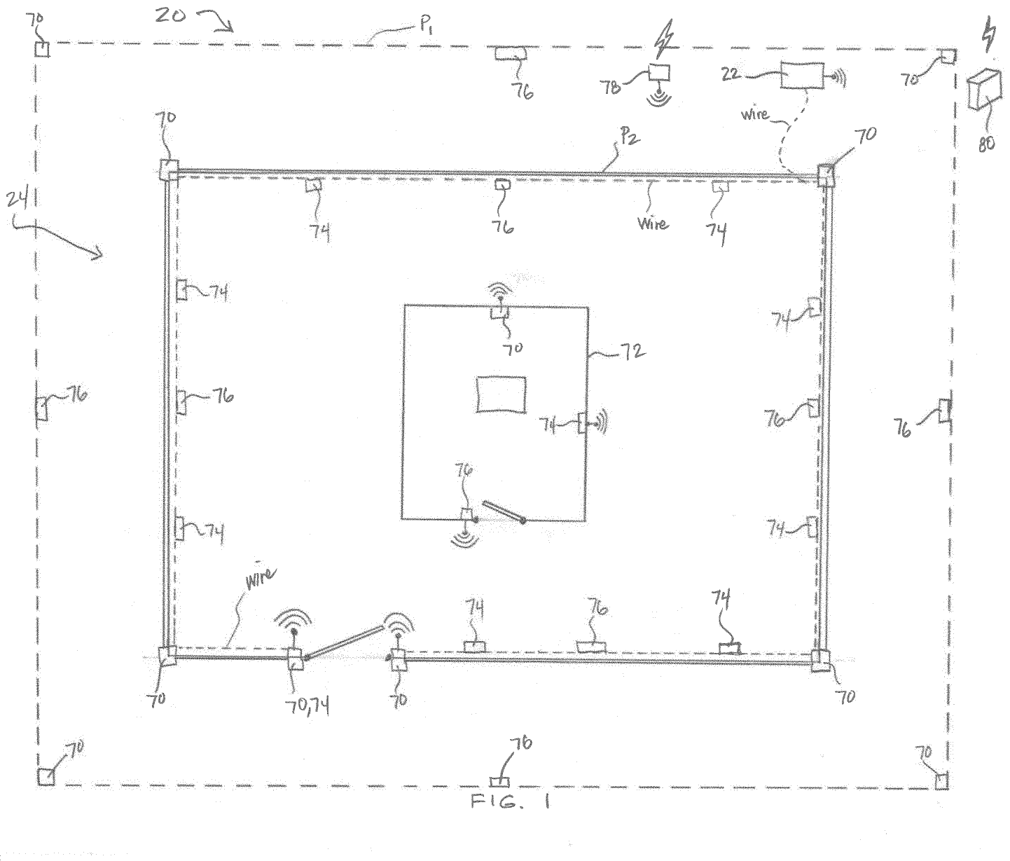

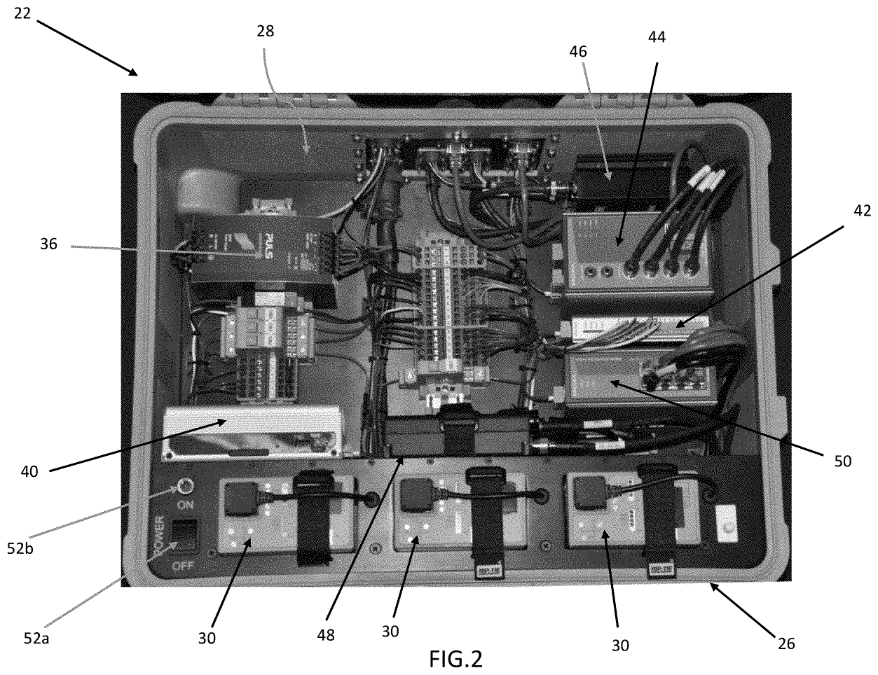

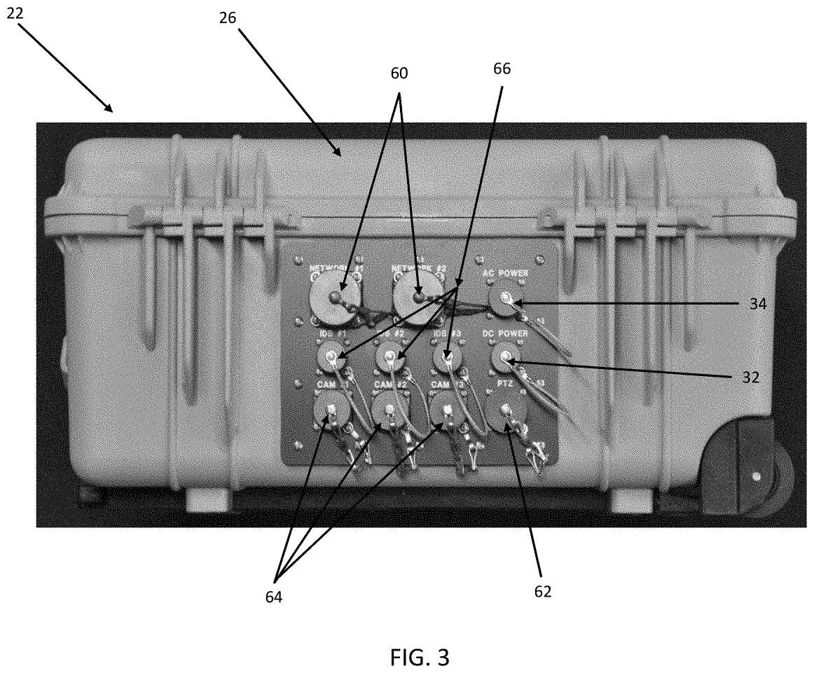

FIG. 1 shows a simplified schematic illustration of a black box system, i.e., the system 20, constructed in accordance with the teachings of the present disclosure. FIGS. 2 and 3 illustrate one of many possible examples of a black box device 22 for use with the system 20 of FIG. 1. The black box device 22 is also constructed in accordance with the teachings of the present disclosure. As shown in FIG. 1 and as described in more detail below, the system 20 includes a plurality of external components that are or can be deployed around, on, and within a premises to be monitored. The various components communicate with the black box device 22, also as described in greater detail below.

FIG. 1 shows a relatively generic schematic of one example of a black box system 20 for a land-based premises 24 defined by a generic property boundary P1 and a generic structure boundary P2. As noted above, the premises 24 can be any land-based potential target for terrorists or other violence. The premises 24 can be a fixed or mobile building, a delineated property, a secure warehouse or storage facility, a military or secure base, a combat outpost, a forward operating base, a residence, a bridge, a communication tower, an airport, a school, an office campus, a stadium, a test facility, power grid and power generation and distribution facility, a tunnel, an embassy, or the like. The black box device 22 can be positioned in the premises 24 at a discrete or relatively safe location or can be disposed outside the premises. The location of the black box device 22, when implemented with a black box system 20 for a premises 24, should be selected so that the black box device is likely to survive any event that harms the premises or the personnel on or in the premises. The black box device 22 can be within the property boundary P1 but outside the structure boundary P2, as in FIG. 1, or can be inside the structure boundary, or can be outside the property boundary.

FIG. 2 shows one example of an array of internal components of the black box device 22 in accordance with the teachings of the present disclosure. FIG. 3 shows one example of exterior components or component connections of the black box device 22 in accordance with the teachings of the present disclosure. The black box device 22 is used as a part of the land-based black box system 20, as depicted in FIG. 3, for buildings, structures, premises, and the like. As used hereinafter, the term “premises” is used to broadly or generically identify any land-based location, such as a fixed or mobile building, a delineated property, a warehouse or storage facility, a military or secure base, a combat outpost, a forward operating base, a residence, a bridge, a communication tower, an airport, a school, an office campus, a stadium, an embassy, and the like. The disclosed system 20 can be incorporated into a premises 24 and can be used to obtain critical real time information and data if the premises is subject to a catastrophe.

In one example, the black box device 22 has a sturdy protective case or shell 26 with an interior 28 constructed to house critical components of the device and of a black box system 20. The case or shell 26 can be formed of any suitable materials and can be an openable and lockable, two-piece, clamshell configuration. In one example, the case or shell 26 can be formed of a high strength, high density polymer material that can survive a catastrophic event, as described herein.

In one example, the black box device 22 can be configured to operate on power provided by one or more power sources. The power sources can include an on-board power source, such as one or more DC batteries 30 housed within the case 26. The black box device 22 can also include a connector or coupling 32 on the exterior of the case 26 for connecting the black box device to an external DC power source such as a generator (not shown). The black box device 22 can also include a connector or coupler 34 on the exterior of the case 26 for connecting the black box device to an external AC power source such as a local power grid (not shown). The power source options can be redundant to provide a back-up to avoid a loss of power to the black box device 22 or system 20 at a critical time. The black box device 22 can also include an internal power supply 36 housed within the case 26 configured to be powered by one or more of the power sources to provide power to the various components of the black box device and the system 20, as needed.

The black box device 22 can also include a central processing unit or CPU 40 that is protected and embedded within the case or shell 26. The CPU 40 can be programmed to control functionality of the black box device 22 and its internal components as well as the remote external components and devices of the system 20. Thus, the CPU 40 can include one or more processors, memory devices, and the like (not shown), as is known in the art. The black box device 22 can also have an input/output (I/O) device 42 housed within the case. The I/O device 42 can be configured to send information, signals, and/or data outside the case or shell 26 to an authorized receiver, described in more detail below. The I/O device 42 can also be configured to send and receive information, signals, and/or data to the internal components within the case 26, as well as the remote external components and devices of the black box system 20. The I/O device 42 may include one or more transceivers (not shown) that can send and receive information, signals, and/or data. These transceivers or another part of the I/O device 42 or the black box device 22 may also include encryption capability to encrypt outgoing and decrypt incoming information, signals, and/or data, if desired.

The black box device 22 can also include a video encoder 44, which may be configured to convert digital video files from one format to another, as needed to accommodate the black box system 20 components and requirements. The video encoder 44 may also be provided to allow for use of analog closed-circuit TV (CCTV) and coaxial cable system components within the black box system 20 to be capable of communicating with a digital video system of the black box device 22 or other system components. The video encoder 44 may enable users to receive the benefit of network or digital video without having to discard existing analog equipment such as analog CCTV cameras and coaxial cabling. The video encoder 44 may also be configured to provide video information, signal, and/or data encryption and decryption functionality for the black box device 22 and system 20.

The black box device 22 can also include a video motion detector 46 that is in communication with remote external components, such as video cameras, of the system 20. The video motion detector 46 can be configured to operate one or more remote external cameras according to motion detected by a camera and the information, signals, and/or data provided by the camera to the motion detector. The video motion detector 46 may also be configured to detect motion in the immediate environment surrounding the black box device 22. When detected, such motion may automatically operate a camera on board the black box device 22. In either case, the video motion detector 46 may be configured to turn one or more cameras on or off and/or to operate the camera(s) to perform other functions, such as zoom, pan, and/or tilt.

The black box device 22 can also include a wireless radio transceiver or capability with encryption, i.e., wireless encrypted radio 48. Thus, the black box device 22 can be configured to send and receive wireless radio frequency (RF) signals. For example, the wireless encrypted radio 48 can be configured to send a beacon or ping for reasons that are described in further detail below. The wireless encrypted radio 48 can also be configured to send and receive wireless information, signals, and/or data to and from the remote external components and system 20 devices, such as the cameras, to control and operate such components and devices.

The black box device 22 can also include an ethernet switch 50. The ethernet switch 50 can be provided as a connection point for the multiple connected devices within the black box device 22. The ethernet switch 50 can also be provided as a connection point for any one or more hard-wired remote external components and system 20 devices. One or more of the ethernet switches 50 can be provided as needed. The black box device 22 can also include a power switch 52a and light emitting diode or LED 52b. The power switch 52a can be configured to turn the black box device ON and OFF as needed for a black box system 20 installation. The LED 52b may simply provide an indication as to whether the device is ON or OFF. The power switch 52a can also be configured to control which power source is activated, which power source is the primary power source, a power source hierarchy, if more than one power source is turned ON, connected, and/or active, and the like.

The black box device 22 may include other internal components above and beyond those shown and described herein for this example. In one example, the black box device 22 can include an antenna 54 coupled to the CPU and other internal components within the case to allow wireless communication between the black box device and remote networks, system 20 components, and/or authorized users or responders, as described below. The antenna may be internal to the case or shell 26 or may be at least in part external to the case. The black box device 22 may also include fewer than the disclosed internal components in this example, if desired, or may include different combinations of such internal components. The disclosure is not limited only the internal components for the black box device 22 example that is shown and described herein.

FIG. 3 shows one of many possible examples of an array of external components or component connections for the disclosed black box device 22 and system 20. In one example, the black box device 22 may include the above-mentioned connections 32, 34 for both an external DC power source and an external AC power source, respectively, to supplement the internal or on-board DC power source 30. The black box device 22 can also include one or more ethernet, i.e., data input and output connections 60 for connecting external remote components to the ethernet switch 50 within the case or shell 26. These connection points can be used to connect the black box device 22 to hard-wired components and devices external to the case 26.

As noted above and in more detail below, the black box system 20 can include one or more remote external components and devices. These devices and components can include one or more cameras, one or more audio devices, one or more sensors, and/or the like. In one example, described in greater detail below, the black box system 20 can include one or more remote external fixed cameras and one or more remote external pan-tilt-zoom (PTZ) cameras. Thus, the black box device 22 can include an appropriate number of camera connection points or ports including PTZ camera ports 62 and fixed camera connections 64 accessible on the exterior of the case or shell 26. Such cameras can be hard-wired to one another and then coupled to the case 26 at these connections. Though not shown herein, the black box system 20 can also include similar connections for audio devices. Thus, the case 26 can include an appropriate number of audio connections (not shown) to hard-wire connect the audio devices to the black box device 22. In one example, the audio devices, such as microphones, may be part of the cameras and thus may not require separate connection points on the case or shell 26, as in this example.

In one example, the black box system 20 may also include one or more remote sensors, such as vibration sensors, seismic sensors, audio sensors, heat sensors, motion sensors, pressure sensors, light sensors, and/or the like. These sensors can be hard-wired to one another and then also to the black box device 22. The case or shell 26 can thus include one or more sensor connections or ports 66 on the case. The sensors can be configured to collect and transmit meta data relevant to the type of sensor via the hard-wire connection to the black box device 22. Further details of such sensors are described below.

Each of the remote external components and devices of the system 20 may be configured for hard-wire connection to one another and/or to the black box device 22. Thus, these components and devices may send and receive information, signals, and/or data to and from the black box device 22 via cables connected to the components and devices and to the case 26 or the black box device. However, any one or more, if not all, of the remote external components and devices can also be configured to be wirelessly operated and/or to wirelessly transmit and receive information, signals, and data. Thus, communication between the black box device 22 can be either by hard-wire connection, by wireless connection, or both as a redundancy.

Referring again to FIG. 1, the premises 24 can be configured with one or more remote (relative to the black box device 22) components or devices of the system 20. Again, these devices and components can include cameras 70 that are strategically placed around the perimeter P of the premises 24, around the perimeter P of a structure on the premises, at strategic locations within and/or throughout the premises, and/or the like, as desired for a given black box system 20 installation. The cameras 70 can be placed at entrances and exits and within critical interior or exterior locations throughout the premises. The cameras 70 can be positioned for over-the-shoulder viewing of security personnel at a specific security point or station 72 at, on, or in the premises 24. The type of cameras 70 utilized can vary and can include, for example, PTZ cameras, fixed cameras, analog cameras, digital cameras, night vision cameras, infra-red cameras, open standard protocol ONVIF surveillance cameras, and the like. The cameras 70 can also be existing security cameras already in place within the premises, where the black box system 20 is simply tied into the existing camera network.

The cameras 70 can obtain and record video of any activity occurring about the premises 24. The cameras 70 can be turned OFF and ON via motion sensor or can be in an always ON mode. The cameras 70 can also be operated remotely from outside the facility through communication with the black box device 22. Alternatively, or in addition, the cameras 70 can be operated remotely, but from within the facility, if desired for a particular system 20 installation.

The cameras 70 may also include audio sensors 74, i.e., microphones as a part of the camera. Alternatively, the devices and components can include separate audio sensors 74, such as microphones, or radio communication devices. The audio sensors 74 and/or radio communication devices can be strategically distributed along the perimeter P and/or at critical interior locations within and around the premises 24, as needed for a particular system 20 installation. Actuation or operation of the audio sensors 74 and devices can be tied to operation of the cameras 70. Alternatively, or in addition, the audio sensors 74 and devices can be operable remotely from outside the premises 24 through communication with the black box device 22. Also, the audio sensors 74 and devices can be operable remotely from within the premises 24. The audio sensors 74 and devices can be turned ON and OFF via motion sensors tied to the cameras 70. Alternatively, or in addition, the audio sensors 74 and devices can be in an always ON mode or can be in an OFF mode and configured to turn ON for a period of time after detecting a predetermined type or level of sound.

The black box system 20 can also include one or more other types of sensors 76. These sensors 76 can include, but are certainly not limited to, vibration sensors, shock sensors, seismic sensors, thermal or heat sensors, motion sensors, pressure or overpressure sensors, gunfire detectors, boomerang sensors, light sensors, visible or invisible perimeter barrier sensors, and/or the like. Any of these sensors 76 can be configured to detect a predetermined threshold activity level of an activity or stimulus related to that type of sensor. These activities or stimuli can include a rapid increase in light intensity, a rapid increase in temperature, a perimeter breach, a significant change in seismic activity, a significant increase or decreas in air pressure, a sudden loss of communication with the black box device 22, or the like. If a sensor 76 is triggered, i.e., if a predetermined threshold is reached, the sensor or sensors 76 can send a signal to the black box device 22 that an event of interest has occurred at the premises 24. These types of events may be called catastrophic events, terror events, triggering events, attacks, or the like. These types of incidents are simply called “events” herein for ease of description. An event may include an explosion, gunfire, a perimeter breach or infiltration by unauthorized personnel, or the like. The cameras 70 and audio sensors 74 may also be configured to detect an event, if desired for a particular system 20 installation.

The black box device 22 can be configured to collect and store data and metadata from the cameras 70, audio sensors 74, and other sensors 76. The black box device 22 and system 20 can be configured to be in an OFF mode, to be turned on by any of the components or devices detecting a threshold stimulus, by detecting an event, or by a panic button accessible to personnel within the premises. Such data and metadata can be retained for a period of time, such as 1 hour, 30, minutes, or other suitable period, and then erased, dumped, or overwritten after such period of time, if an event of interest has not been detected. However, if the black box system 20 has detected an event of interest, the black box device 22 can trigger an event driven response. This event driven response can include retaining and storing all data obtained prior to the event from the cameras 70, audio sensors 74, and other sensors 76.

The event driven response may also include any number of additional response activities and sequences, as desired for a particular installation. For example, the event driven response may include the black box device 22 or system 20 sending out an encrypted signal, such as a wireless signal, to a remote user or network that an event has occurred. The event driven response may also include the black box device 22 generating a signal or ping to be detected by a remote user or authorized responder within a specified range of the black box device. The remote user or authorized responder may then be capable of physically locating the black box device 22 after the event via locating the signal or ping. Alternatively, the remote user or authorized responder may be able to gain close enough proximity to the black box device 22, such as within a block or two, via the signal or ping, to access and download all the stored data and metadata from the black box device. Thus, the user or responder need not be required to physically locate and manually tap into the black box device 22 after an event, as the black box device might not be accessible in the immediate aftermath of the event. The black box device 22 can be configured so that only an authorized user or responder has the appropriate code or codes, technological device, or gadget 78 in hand to provide the capability to decrypt the data and/or to access and download the data and metadata. Such download can be via a secure wireless connection between the authorized responder's device 78 and the black box device 22.

The event drive response may also include that each camera 70, audio sensor 74, and/or other sensor 76, if still operating during or after the event, continue to operate and to collect and send information, signals, and/or data to the black box device 22. Likewise, the event driven response may also include the remote user or authorized responder being able to continue to receive or download this continued data stream after the event. Further, the event driven response may also include the remote user or authorized responder being able to communicate with and operate or control any of the remote components and devices 70, 74, 76 that are still operating after the event. Though it might not be a secure enough transmission, the event driven response could also include having the stored and continued stream data and metadata being uploaded in an encrypted form to a predetermined destination server 80 or system.

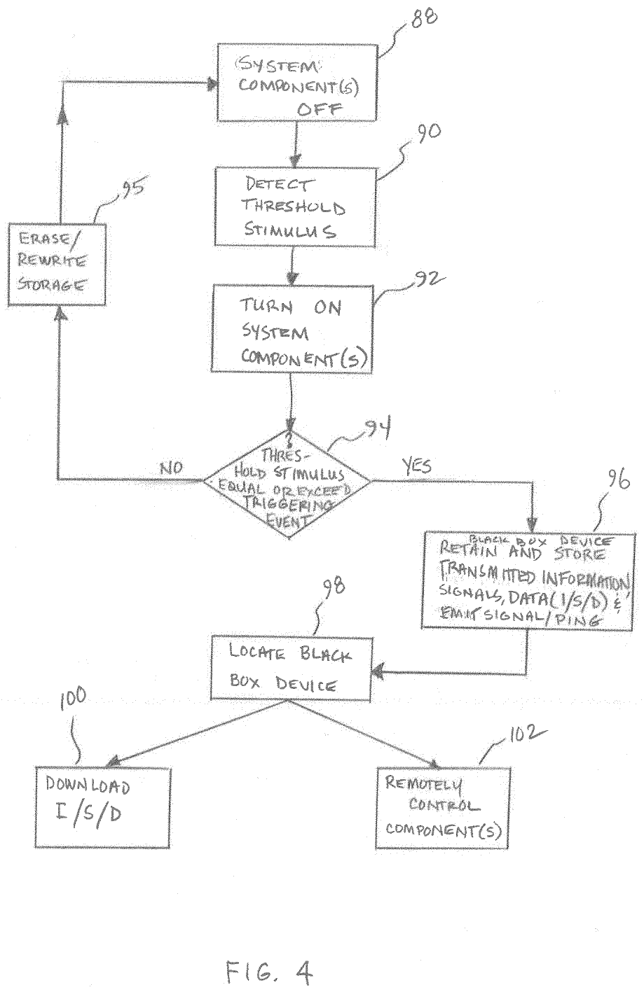

FIG. 4 shows one example of a flow chart of a method of obtaining, storing, and retrieving information, signals, and data from a land-based premises, building, structure, or the like. The system 20 and components may be in an OFF or inactive condition in a normal operating state, as indicated at step 88. At step 90, the system 20 may detect a threshold stimulus via any one or more of the cameras 70, audio sensors 74, or other sensors 76. In one example this can turn ON the one or more components of the system 20, such as all the cameras 70, audio sensors 74, and sensors 76 at step 92. In another example, detecting a threshold stimulus by, for example, a camera 70, may turn ON only the cameras of the system 20, whereby the audio sensors 74 and other sensors 76 are only turned ON if one of the audio sensors or other sensors detects a corresponding threshold stimulus.

The system can then determine at step 94 if the detected stimulus includes an event of interest, i.e., a catastrophic or triggering event associated with the premises 24. If not, the cameras 70, audio sensors 74, and other sensors 76 can eventually turn OFF after a predetermined period of time as indicated at step 95. Any information, signals, or data stored by the black box device 22 within that period of time can be wiped or erased. If at step 94 the stimulus is determined to be an event of interest, i.e., the detected stimulus meets an event threshold such as a perimeter breach or a sound or vibration threshold, all the cameras 70, audio sensors 74, and other sensors 76 can continue operation while functional. The information, signals, and data retrieved and stored is retained at step 96 and the system 20 will continue to collect and store information, signals, and data from all functional components of the system.

After an event of interest at step 98, a responder can locate the black box device 22. This can be done physically and manually or can be done remotely by receiving a ping from the device. Once located, the responder can access and download the information, signals, and data from the black box device 22 at step 100. This again can be done manually at the black box device 22 or can be done remotely via a wireless connection and using a secure or encrypted communication method. For example, the responder may have a specific secure gadget that can communicate with and control the black box device 22, once detected. At step 102, the responder can also attempt to control aspects of the black box system 20 through the secure communication with the black box device 22. In one example, the responder may wish to manipulate one or more of the cameras 70 or audio sensors 74 for a specific purpose or to acquire specific and/or ongoing data for reasons dictated by characteristics of the event.

The black box system 20 and black box device 22 and components described herein can be configured using, or to be compatible with, various existing or to-be-developed electronic and computer technologies. The CPU 40 can include a set of instructions that can be executed to cause the CPU to perform any one or more of the methods or computer-based functions disclosed and described herein. The CPU 40 may operate as a standalone device or may be connected, e.g., using a network, to other computer systems or peripheral devices, either within the case or shell 26 or remote from the case. Any of the components discussed herein, such as the CPU 40, may be or emulate a computer system. The CPU 40 may be specifically configured to implement various operations and functions for the black box device 22, the black box system 20, and the various remote external components and devices of the system.

In a networked deployment, the CPU 40 may operate in the capacity of a server or as a client user computer in a client-server user network environment, or as a peer computer system in a peer-to-peer (or distributed) network environment with one or more processors of the various components and devices of the black box system 20. Other of the components and devices of the black box device 22 or system 20 may include a separate processor, if desired. In one example, the CPU 40 can be implemented with electronic devices that provide voice, video, or data communication. Further, while a single CPU 40 is illustrated and described, the term “system” shall also be taken to include any collection of systems, sub-systems, or linked components and devices that individually or jointly execute a set, or multiple sets, of instructions to perform one or more computer functions.

The CPU 40 may be or include one or more general processors, digital signal processors, specifically configured processors, application specific integrated circuits, field programmable gate arrays, servers, networks, digital circuits, analog circuits, combinations thereof, or other now known or later developed devices for analyzing and processing data. The CPU 40 and other system processors may each implement a software program, such as code generated manually (i.e., programmed).

The CPU 40 may include a memory that can communicate via a bus. The memory may be a main memory, a static memory, or a dynamic memory. The memory may include, but is not limited to, computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media, and the like. In one example, the memory can include a cache or random-access memory for the CPU 40. In alternative examples, the memory can be separate from the CPU 40, such as a cache memory of a processor, the system memory, or other memory. The memory may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory is operable to store instructions executable by the CPU 40. The functions, acts, or tasks described herein may be performed by the programmed CPU 40 executing the instructions stored in the memory. The functions, acts, or tasks are independent of the particular type of instruction set, storage media, processor, or processing strategy, and may be performed by software, hardware, integrated circuits, firm-ware, micro-code, and the like, operating alone or in combination. Likewise, processing strategies may include multiprocessing, multitasking, parallel processing, and the like.

Additionally, the CPU 40 may include an input device configured to allow a user to interact with any of the components of the CPU or the black box device 22. The input device may be a number pad, a keyboard, or a cursor control device, such as a mouse, or a joystick, touch screen display, wired or wireless remote control, or any other device operative to interact with the CPU 40.

The CPU 40 may also include a disk or optical drive unit. The disk drive unit may include a computer-readable medium in which one or more sets of instructions, e.g., software, can be embedded. Further, the instructions may embody one or more of the methods, operations, functions, or logic as described herein. In one example, the instructions may reside completely, or at least partially, within the memory and/or within the processor during execution by the CPU 40. The memory and the processor also may include computer-readable media as discussed herein.

The present disclosure contemplates a computer-readable medium that includes instructions or receives and executes instructions responsive to a propagated signal, so that one or more components and devices connected to the system 20 network can communicate voice, video, audio, images, or any other data over the system network. Further, the instructions may be transmitted or received over the network via a communication interface. The communication interface may be a part of the processor or CPU 40 or may be a separate component. The communication interface may be created in software or may be a physical connection in hardware. The communication interface may be configured to connect with other remote external components and devices of the black box system 20 and/or with other internal components of the black box device 22, or combinations thereof. The connection with the internal components may be a physical connection, such as a wired Ethernet connection or may be established wirelessly. Likewise, the additional connections with other external components and devices of the system may be physical connections or may be established wirelessly.

The black box system 20 network may include wired networks, wireless networks, or combinations thereof. The wireless network may be a cellular telephone network, an 802.11, 802.16, 802.20, or WiMax network. Further, the black box system 20 network should be a private network, such as an intranet, and may utilize a variety of networking protocols now available or later developed including, but not limited to, TCP/IP based networking protocols. Wireless signals may be RF signals and may be transmitted via antenna and transceivers within the system or may be transmitted via satellite.

Examples of the subject matter and the functional operations described in this specification can be implemented in digital electronic circuitry, or in computer software, firmware, or hardware, including the structures disclosed in this specification and their structural equivalents, or in combinations of one or more of them. Examples of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a non-limiting example, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated or otherwise specifically configured hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more examples described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular examples with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random-access memory or both. The essential elements of a CPU may be a processor for performing instructions and one or more memory devices for storing instructions and data. Generally, the CPU 40 may also include, or be operatively coupled to receive data from or transfer data to, or both, one or more mass storage devices for storing data, e.g., magnetic, magneto optical disks, or optical disks. However, the CPU 40 need not have such devices. Moreover, the CPU 40 can be embedded in another device or component of the black box device 22. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

As used herein, the terms “microprocessor” or “general-purpose processor” (“GPP”) may refer to a hardware device that fetches instructions and data from a memory or storage device and executes those instructions (for example, an Intel Xeon processor or an AMD Opteron processor) to then, for example, process the data in accordance therewith. The term “reconfigurable logic” may refer to any logic technology whose form and function can be significantly altered (i.e., reconfigured) in the field post-manufacture as opposed to a microprocessor, whose function can change post-manufacture, e.g. via computer executable software code, but whose form, e.g. the arrangement/layout and interconnection of logical structures, is fixed at manufacture. The term “software” may refer to data processing functionality that is deployed on a GPP. The term “firmware” may refer to data processing functionality that is deployed on reconfigurable logic. One example of a reconfigurable logic is a field programmable gate array (“FPGA”) which is a reconfigurable integrated circuit. An FPGA may contain programmable logic components called “logic blocks”, and a hierarchy of reconfigurable interconnects that allow the blocks to be “wired together”, somewhat like many (changeable) logic gates that can be inter-wired in (many) different configurations. Logic blocks may be configured to perform complex combinatorial functions, or merely simple logic gates like AND, OR, NOT and XOR. An FPGA may further include memory elements, which may be simple flip-flops or more complete blocks of memory.

To provide for interaction with a user, examples of the subject matter described in this specification can be downloaded or uploaded to another remote computer or electronic device from the black box device 22. Such a remote device can then utilize a display, e.g., a CRT (cathode ray tube) or LCD (liquid crystal display) monitor, for displaying information to the user and a keyboard and a pointing device, e.g., a mouse or a trackball, by which the user can provide input to the remote computer or electronic device. Other kinds of remote devices can be used to provide for interaction with a user as well. Feedback provided to the user from the remote electronic device or computer can be any form of sensory feedback, e.g., visual feedback, auditory feedback, or tactile feedback. Input from the user to the remote electronic device or computer can be received in any form, including acoustic, speech, or tactile input.

Although certain black box devices and black box systems for land-based premises have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A black box system for a land-based premises, the system comprising:
a black box device located in or near the premises, the black box device having a destruction resistant case or shell and operational components housed within the case or shell; and
at least one remote component external to and in communication with the black box device and disposed at, on, or in the premises, the remote component configured to collect information, signals, and/or data about premises conditions and to transmit the collected information, signals, and/or data to the black box device,
wherein the black box device receives the transmitted information, signals, and/or data from the remote component,
wherein the black box device stores the transmitted information, signals, and/or data for a period of time before and/or during a triggering event, and
wherein the stored transmitted information, signals, and/or data can be retrieved from the black box device after the triggering event.

2. The black box system of claim 1, wherein the remote component continues to transmit information, signals, and/or data to the black box device after the triggering event.

3. The black box system of claim 1, wherein the stored transmitted information, signals, and/or data can be retrieved by an authorized responder via a secure wireless transmission.

4. The black box system of claim 1, wherein the case or shell is formed of a high strength, high density polymer.

5. The black box system of claim 1, wherein the black box device is configured to emit a transponder signal or ping upon the occurrence of the triggering event.

6. The black box system of claim 1, wherein the black box device is configured to erase, delete, or overwrite expired or old stored transmitted information, signals, and/or data after the period of time passes and when no triggering event has occurred and is configured to collect new stored transmitted information, signals, and/or data.

7. The black box system of claim 1, wherein the remote component and the black box device are in wireless electronic communication, hard-wired electronic communication, or both.

8. The black box system of claim 1, wherein the remote component includes a plurality of remote components.

9. The black box system of claim 8, wherein the plurality of remote components includes one or more of a camera, an audio sensor, and a non-audio sensor.

10. The black box system of claim 9, wherein the plurality of remote components includes one or more cameras, one or more audio sensors, and one or more non-audio sensors.

11. The black box system of claim 1, wherein the at least one remote component includes at least one non-audio sensor, which is selected from a group comprising a heat or thermal sensor, a perimeter breach sensor, a pressure or over-pressure sensor, a shock sensor, a seismic sensor, a vibration sensor, and a light sensor.

12. A method of obtaining information, signals, and/or data from a land-based premises, the method comprising the steps of:
detecting a stimulus at or above a stimulus threshold via a component of a black box system installed at the land-based premises;
turning ON the component;
transmitting information, signals, and/or data from the component to a black box device of the black box system, the black box device located remote from the component and in or near the premises;
storing the transmitted information, signals, and/or data at the black box device;
determining at the black box device if the detected stimulus meets or exceeds a triggering event threshold;
if the detected stimulus meets or exceeds the triggering event threshold, retaining the stored transmitted information, signals, and/or data at the black box device, and emitting a transponder signal or ping from the black box device; and
if the detected stimulus does not meet or exceed the triggering event threshold, after a predetermined period of time, turning OFF the components and erasing the stored transmitted information, signals, and/or data.

13. The method of claim 12, wherein the component of the black box system further has a plurality of components including one or more cameras, one or more audio sensors, and one or more other non-audio sensors, and wherein the step of turning ON includes turning ON each of the one or more cameras, audio sensors, and other non-audio sensors.

14. The method of claim 12, further comprising the steps of locating the black box device based on the transponder signal or ping and downloading the stored transmitted information, signals, and/or data.

15. The method of claim 14, wherein the step of downloading is performed remote from the black box device via a secure wireless transmission.
